(19) United States
(12) Patent Application Publication
(10) Pub. No.: US 2015/0274021 A1
(43) Pub. Date: Oct. 1, 2015

(54) CONTROL DEVICE FOR VEHICLE

(71) Applicant: Toyota Jidosha Kabushiki Kaisha, Toyota-shi Aichi-ken (JP)

(72) Inventor: Ryoji Sato, Toyohashi-shi Aichi-ken (JP)

(21) Appl. No.: 14/631,986

(22) Filed: Feb. 26, 2015

(30) Foreign Application Priority Data
Apr. 1, 2014 (JP) 2014-075068

(51) Int. Cl. B60L 7/18; B60L 11/18

(52) U.S. Cl. CPC B60L 7/18; B60L 11/1803; B60L 11/1862; Y10S 903/947

(57) ABSTRACT

A vehicle control device includes a battery, a boost converter connected to the battery, for boosting battery voltage, a second inverter connected to the boost converter for carrying out direct current/alternating current conversion, a second MG connected to the second inverter, for outputting drive force, and an SOC sensor for detecting charged state of the battery. The control section, when the SOC that has been detected by the SOC sensor exceeds a first threshold value, raises the output voltage of the boost converter compared to when the SOC is below the first threshold value. In this way it is possible to sufficiently utilize regenerative braking and braking without any unpleasant feeling is possible.

### RELATED APPLICATION INFORMATION

This application claims priority to Japanese Patent Application No. 2014-075068, filed on Apr. 1, 2014, the entire content of which is incorporated herein by reference.

### BACKGROUND

1. Technical Field

The present invention relates to a control device for a vehicle that efficiently consumes regenerative electrical power.

Regenerative braking is used in hybrid vehicles (HV) and electric vehicles (EV) at the time of deceleration, and a battery is charged using recovered electrical power.

Here, if a battery charged state (SOC) is already high, no further charging can be carried out. Specifically, excessive charging of the battery would cause damage to the battery and so must be avoided.

With patent publication 1, when SOC is high, engine operating point is changed and the engine forcibly turned to achieve deceleration utilizing engine loss. In this way it is possible to prevent excessive rise in SOC.

### PRIOR ART REFERENCES

Patent publication 1

JP 08-207600A

### SUMMARY

With patent publication 1, if the above-described control is commenced rotational speed of the engine rises rapidly. Rapid rise in engine rotation speed without also shifting down during deceleration gives an unpleasant sensation to the driver. It is likely that the driver will feel as if they are accelerating.

It is desired to decelerate without causing any unpleasant sensation such as rise in engine rotation speed, while reducing rise in SOC.

The present invention comprises a battery, a boost converter connected to the battery, for boosting battery voltage, an inverter, connected to the boost converter, for carrying out DC/AC conversion on output of the boost converter, a motor generator, connected to the inverter, for outputting drive force, a charge state detection section 4 detecting charged state of the battery, and a control section for raising output voltage of the boost converter when the charge state that has been detected by the charge state detection section has exceeded a first threshold value, compared to when the charge state is the first threshold value or less.

Also, with one embodiment, when the charged state exceeds a second threshold value that is higher than the first threshold value, the motor generator is driven under field-weakening control.

Also, with another embodiment, when the charge state exceeds a second threshold value that is high than the first threshold value, in the event that PWM control is not performed the engine operating point is changed to a state where engine loss is large, without carrying out field-weakening control.

Also, with yet another embodiment, a vehicle has a D range for normal travel, and a B range for travel with vehicle deceleration that is larger than the D range, as selectable travel ranges, and the first threshold value and second threshold value are respectively set to be lower when running in the B range compared to when running in the D range.

By making output voltage of the boost converter (boost voltage VH) high, it is possible to make energy loss at the boost converter and the inverter large, and consume electrical power from regenerative braking. Here, regenerative braking is carried out while inhibiting rise in SOC. Deceleration is carried out without any unpleasant sensation such as increasing engine rotation speed etc.

### BRIEF DESCRIPTION OF THE DRAWINGS

FIG. 1 is a block diagram showing the overall structure of a vehicle drive system.

FIG. 2 is a drawing showing structure of a boost converter.

FIG. 3 is a flowchart showing control in accordance with SOC.

FIG. 4 is a flowchart showing a modified example of control in accordance with SOC.

### DESCRIPTION OF PREFERRED EMBODIMENTS

Embodiments of the present invention will be described in the following based on the drawings. The present invention is not limited by the embodiments described herein.

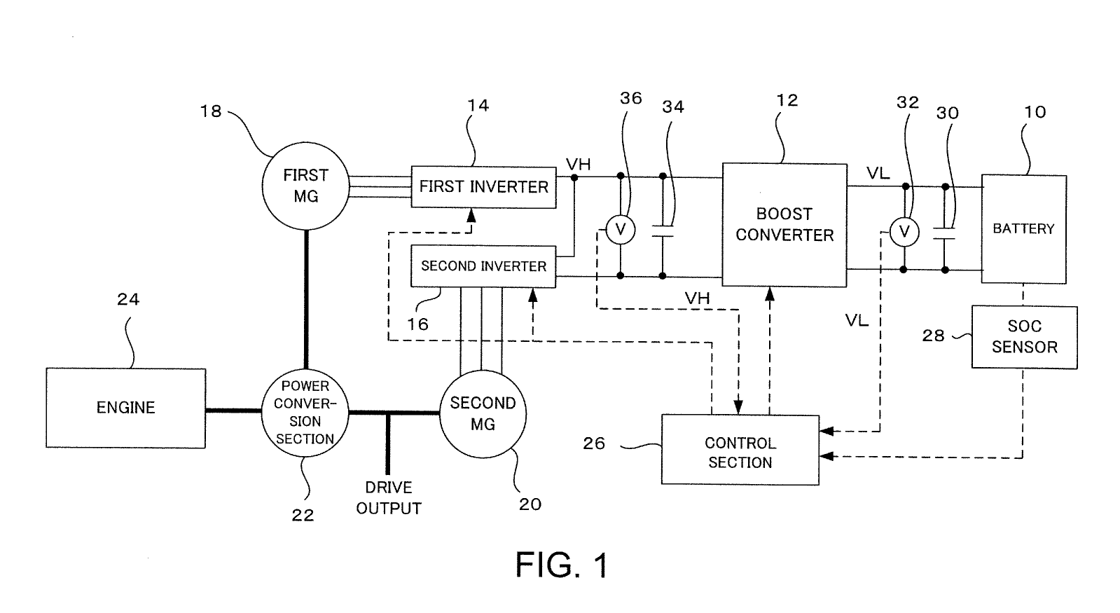

FIG. 1 is a schematic block diagram showing a drive system for a hybrid vehicle. Direct current output of a battery 10 is boosted by a boost converter 12, and then supplied to a first inverter 14 and a second inverter 16. A first MG (motor generator) 18 for electricity generation is connected to the first inverter 14, and a second MG (motor generator) 20 for drive is connected to the second inverter 16.

Output shafts of the first MG 18 and the second MG 20 are connected to a power conversion section 22, and an output shaft of an engine 24 is also connected to this power conversion section 22. Also, rotation of an output shaft connecting the conversion section 22 and the second MG 20 is transmitted to a drive shaft of the vehicle as drive output, while output of the conversion section 22 and/or the second MG 20 is transmitted to the vehicle wheels, thus driving the hybrid vehicle.

The conversion section 22 is formed as a planetary gear train, for example, and controls power transmission between the first MG 18, second MG 20 and engine 24. The engine 24 is basically used as a drive force output source, and output of the engine 24 is transmitted to the first MG 18 by means of the conversion section 22. In this way, the first MG 18 generates electrical power using output of the engine 24, and the obtained generated electrical power is charged into the battery 10 by means of the first inverter 14 and the boost converter 12. Also, output of the engine 24 is transmitted to a drive shaft by means of the conversion section 22, and the vehicle travels using output of the engine 24. In FIG. 1, an electrical power transmission system is shown by normal solid lines, a mechanical drive force transmission system is shown by bold solid lines, and a signal transmission system (control system) is shown by dotted lines.

A control section 26 controls outputs to the drive shaft by controlling drive of the first and second inverters 14 and 16, and the engine 24, in accordance with a target torque determined from accelerator depression amount and engine speed. Also, a SOC sensor 28 is provided as a charge state detection section for detecting the charge state (SOC) of the battery 10, and the detected SOC is supplied to a control section 26. The control section 26 controls charging of the battery 10 by controlling drive of the engine 24 and switching of the first inverter 14 in accordance with SOC of the battery 10 that has been detected by the SOC sensor 28. As the SOC sensor 28 it is possible to adopt any of various well-known devices that integrate charge and discharge current or perform calculation from battery open voltage etc., provided it is possible to detect SOC of the battery 10.

At the time of vehicle deceleration, regenerative braking is carried out by controlling the second inverter 16 and using the second MG 20, and the battery 10 is charged using the acquired regenerative electrical power. It is also possible to carry out regenerative braking using the first MG 18.

In this embodiment, a capacitor 34 for smoothing output voltage of the battery 10 is provided at the output side of the battery 10, as well as a pre-boost voltage sensor 32 for measuring voltage of this capacitor 30 (pre-boost voltage VL). Also, a capacitor 34 for smoothing output voltage is provided at the output of the boost converter 12, as well as a boost voltage sensor 36 for measuring voltage of this capacitor 34, namely input voltage of the first and second inverters 14 and 16 (boost voltage VH).

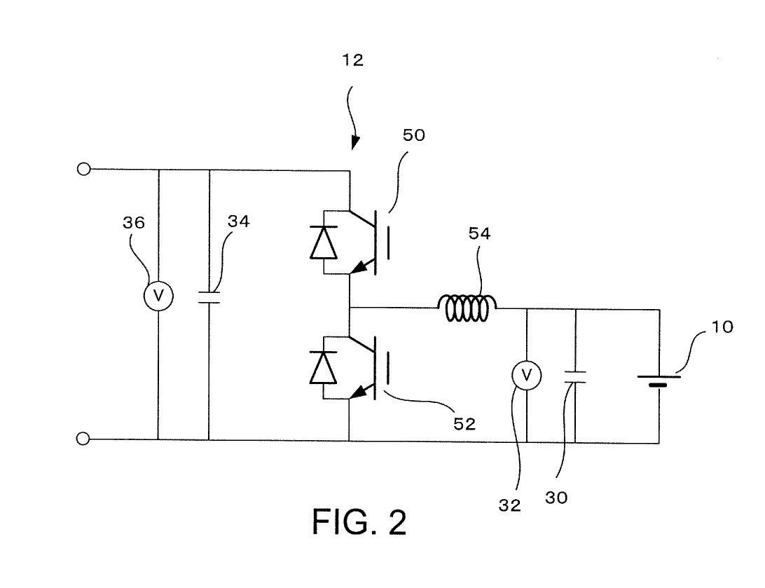

Internal structure of the boost converter 12 is shown in FIG. 2. The boost converter 12 comprises two switching elements 50 and 52 connected in series, and a single reactor 54 connected to an intermediate point between the switching elements 50 and 52. Each of the switching elements 50 and 52 is made up of an IGBT transistor or the like, and a diode in which reverse direction current of this transistor flows.

One end of the reactor 54 is connected to a positive terminal of the battery 10, with the other end of the reactor being connected to the intermediate point between the switching elements 50 and 52. The switching element 50 has a transistor collector connected to a positive terminal bus line of the first and second inverters 14 and 16, while the emitter is connected to the collector of the switching element 52. The emitter of the transistor of the switching element 52 is connected to the negative terminal of the battery 10, and to a negative bus line of the first and second inverters 14 and 16.

The control section 26, as has been described above, outputs a target torque as a drive output, and controls the first and second inverters 14 and 16, and the engine 24, so that a required generated electrical power is obtained.

The control section 26 also controls switching elements and 52 of the boost converter 12 such that the boost voltage VH becomes the target value. This control is carried out by performing feedback control so that the boost voltage VH that has been detected by the boost voltage sensor 36 matches the target value. It is also possible to combine with control so that a reactor current flowing in the reactor 54 becomes a target value.

### <Processing At The Time Of Deceleration When SOC Is High>

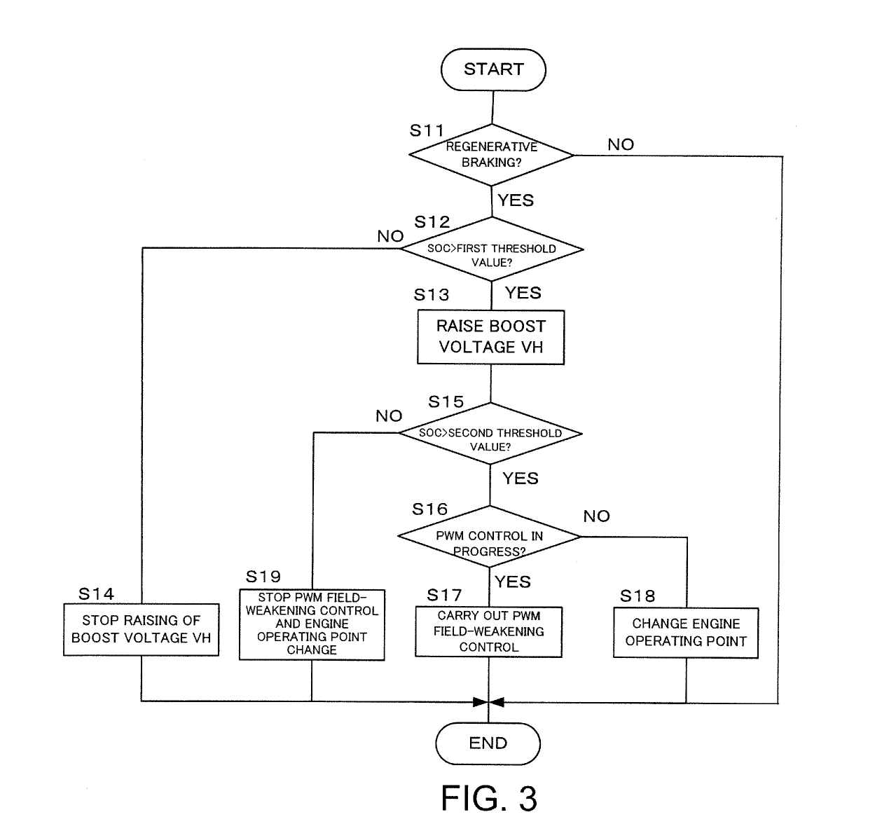

Processing at the time of deceleration will be described based on FIG. 3. It is first determined whether regenerative braking is being carried out (S11). If the result of this determination is NO, there is no need for processing relating to electrical power generated by regenerative braking, and processing is terminated.

### <Raising Of Boost Voltage VH>

If the result of the determination in S11 is YES, it is determined, based on a detection result of the SOC sensor 28, whether the SOC of the battery 10 exceeds the first threshold value (S12). Here, the first threshold value for SOC is set to about 70%, for example. There will always be situations during travel where the vehicle needs to decelerate, and in these situations it is desired to carry out regenerative braking. It is therefore a goal to always control SOC to be 40-60%. The reason for this is that if SOC exceeds 70% effective regenerative braking may not be performed. Obviously the numerical value shown here is merely an example, and is not limiting. For example, in a case where a route to a destination is set, and it is possible to predict generated electricity amount due to regenerative braking along that route etc., these numerical values can be changed based on that prediction. There may also be situations where it is preferable to change threshold values in accordance with power consumption at the time of normal travel of the vehicle and battery capacity.

If the determination in S12 is YES, the boost voltage VH, which is the output voltage of the boost converter 12, is raised (S13). At the time of normal operation, a boost voltage command is determined so that energy loss from the operating conditions at that time becomes minimum, and boost voltage VH is controlled so as to become this boost voltage command value (optimum boost voltage VH). In S13, the boost voltage VH is changed to a higher value than the optimum boost voltage, for example, the maximum voltage of the system. As energy loss, there are boost loss of the boost converter 12, and switching loss in the inverter for drive to the motor generator (second MG 20), for example.

As a result, boost loss of the boost converter 12 and energy loss of the second MG 20 (and/or the first MG 18) become large, and of the electrical power obtained by regenerative braking, it is possible to reduce that which is used to charge the battery 10. Accordingly, it is possible to inhibit increase in SOC of the battery 10. Energy loss is also increased by making the boost voltage VH lower than the optimum boost voltage, but this may affect drive power of the vehicle. Therefore, making the boost voltage VH lower than the optimum boost voltage should only be carried when vehicle drive power is not limited.

If the determination is NO in S12, in the event that the boost voltage VH is being raised, this is stopped, and the boost voltage VH is returned to the optimum boost voltage (S14), and processing is terminated.

In this way, by making loss at the boost converter large it is possible to inhibit raising of the SOC. Accordingly, there is no need to increase loss due to engine friction, as in patent publication 1, and it is possible to reduce any unpleasant sensation for the driver due to rise in engine rotation speed. In particular, by making the boost voltage VH the system maximum voltage, it is possible to maximize boost loss, and it is possible to sufficiently inhibit rise in SOC. The time period in which braking can be carried out using regenerative braking of the motor generator can be prolonged, and it is possible further alleviate any unpleasant sensation experienced by the driver.

### <Carrying Out Field-Weakening Control>

In this way, in the event that SOC is above the first threshold value, the boost voltage is raised in S13, and raising of SOC is inhibited. However, there may be cases where boost voltage VH is raised and energy loss is raised further.

It is therefore determined whether SOC has exceeded a second threshold value that is higher than the first threshold value. In FIG. 3, a transition to step S15 has been described after carrying out the processing of S13, but if the determination in S11 is YES processing may skip to the determination of S15. Specifically, processing to raise the boost voltage and processing to carry out field-weakening may be carried out in parallel.

When the determination in S15 is YES, whether PWM control is in progress is determined (S16). If the determination in S16 is YES, field-weakening control is carried out in PWM control. Specifically, compared to normal control d axis current is made small. In this way motor current is raised and copper loss increased, without causing a variation in drive force (braking force) of the motor generator. While this field-weakening control is often carried out at the time of high rotational speed, the control content itself is identical. d axis and q axis current commands at the time of field-weakening control may be determined from a map for field-weakening that is stored in advance, based on torque command.

Basically, d axis current and q axis current are set so as to maximize efficiency with respect to required output. Accordingly, by carrying out field-weakening control efficiency is lowered to cause energy consumption. Also, by making d axis current small, motor current is made large to increase copper loss. Further, since motor current is increased switching loss of the switching elements of the inverter, and ON loss due to ON resistance, are increased.

In this way, by carrying out field-weakening control energy loss becomes large, and within regenerative electrical power acquired through regenerative braking, electrical power used to charge the battery 10 can be reduced, and it is possible to inhibit increase in SOC of the battery 10.

### <Change To Engine Operating Point>

In this example, control of the motor generator is either PWM control or square wave control. Therefore, if the determination in S16 is NO, it is determined that square wave control is being carried out. When square wave control is being carried out, the operating point of the engine 24 is changed (S18). Specifically, deceleration can be ensured due to friction loss by forcibly rotating the engine 24 as mentioned in patent publication 1. In the case of square wave control, output of the motor generator is large output, and since field-weakening control is not possible deceleration using this type of engine 24 is used.

In the case of a NO determination in S15, in the event that field-weakening control or change of engine operating point are being carried out, this is canceled (S19), and processing is terminated.

### <Overall Concept>

In this way, with the processing of FIG. 3, the control section 26 adopts the three processes of (i) boost voltage rise (ii) field-weakening control and (iii) engine operating point change, in accordance with conditions, and using these processes increases energy loss to thereby effectively inhibit increase in SOC of the battery 10 using regenerative electrical power. As a result, regenerative braking can be carried out while inhibiting increase in SOC, to carry out braking without any unpleasant sensation.

### <Processing Depending On Travel Range>

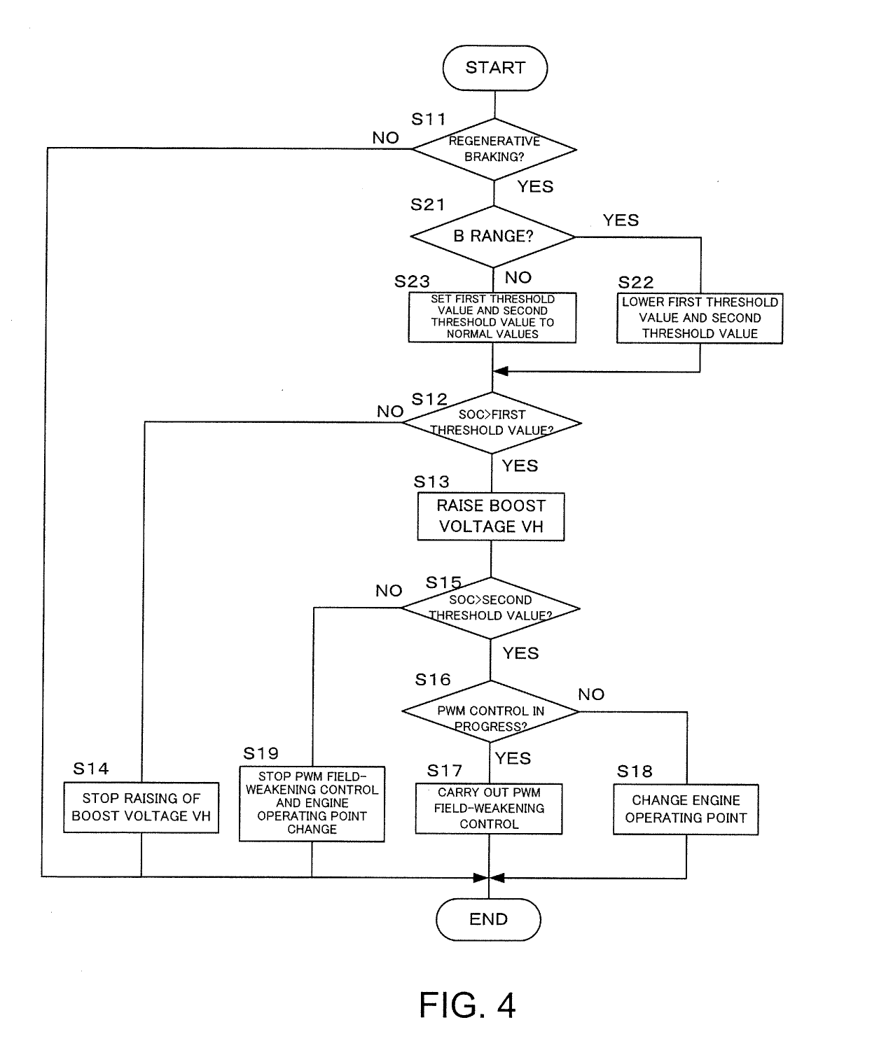

FIG. 4 shows processing dependent on travel range. With this example, in the case of a YES determination in S11, a first threshold value and a second threshold value are changed in accordance with travel range leading to step S12.

With this example, if there is a YES determination in S11 it is determined whether or not a travel range is a B range (S21). The B range is a range in which the vehicle travels with larger deceleration than the D range where normal travel is carried out. For example, fourth gear of a manual transmission is the D range, and third gear and lower are the B range. Accordingly, in S21 it is determined whether it is a range having more acceleration and deceleration than the D range.

If the determination in S21 is YES, the values for the first threshold value and the second threshold value are made smaller (S22). For example, the second threshold value is set to 60% and the second threshold value is set to 70%. When the travel range is set to B range, a travel with high deceleration is anticipated, and it is accordingly expected that regenerative electrical power will be large. By setting the first threshold value and the second threshold value to small values, processing to make energy loss large, using S13, S17 and S18, is commenced with SOC at a comparatively low level. As a result, it becomes possible to prevent SOC rising significantly due to regenerative electrical power when traveling with high deceleration.

In the event of a NO determination in S21, the first threshold value and the second threshold value are returned to normal values (S23). Then, when the first threshold value and the second threshold value have been set in S22 and S23, processing in S12 and after is carried out.

As a result, in the D range a period in which travel with low loss can be carried out becomes comparatively long, and it is possible to inhibit energy inefficiency. Also, in the B range, since deceleration is required, the unpleasant feeling of engine speed rising beyond that caused by the driver downshifting during deceleration will occur often. With this embodiment, it is possible to alleviate any unpleasant feeling the drive experiences by making the situation where control, that causes variation in engine speed to occur, is carried out, comparatively infrequent.

### <Others>

The processing of S17 and S18 increases energy consumption of switching elements of the inverters etc. As a result, the temperature of these switching elements rises. Therefore, in the event that temperature of the switching elements is above a specified temperature, processing of S17 and S18 is prohibited, and where possible cooling capacity of the inverters etc. intensified.

What is claimed is:

1. A control device for a vehicle, comprising:
a battery;
a boost converter connected to the battery, for boosting battery voltage;
an inverter, connected to the boost converter, for carrying out DC/AC conversion on output of the boost converter;
a motor generator, connected to the inverter, for outputting drive force;
a charge state detection section 4 detecting charged state of the battery; and
a control section for raising output voltage of the boost converter when the charge state that has been detected by the charge state detection section has exceeded a first threshold value, compared to when the charge state is the first threshold value or less.

2. The control device for a vehicle of claim 1, wherein:
when the charged state exceeds a second threshold value that is higher than the first threshold value, the motor generator is driven under field-weakening control.

3. The control device for a vehicle of claim 2, wherein:
when the charge state exceeds a second threshold value that is higher than the first threshold value, in the event that PWM control is not performed the engine operating point is changed to a state where engine loss is large, without carrying out field-weakening control.

4. The control device for a vehicle of claim 1, wherein:
as selectable travel ranges there are a D range for normal travel, and a B range for travel with more vehicle deceleration than in the D range, and
the first threshold value and the second threshold value are respectively set to lower values when traveling in the B range compared to when traveling in the D range.

5. The control device for a vehicle of claim 2, wherein:
as selectable travel ranges there are a D range for normal travel, and a B range for travel with more vehicle deceleration than in the D range, and
the first threshold value and the second threshold value are respectively set to lower values when traveling in the B range compared to when traveling in the D range.

6. The control device for a vehicle of claim 3, wherein:
as selectable travel ranges there are a D range for normal travel, and a B range for travel with more vehicle deceleration than in the D range, and
the first threshold value and the second threshold value are respectively set to lower values when traveling in the B range compared to when traveling in the D range.
